(19) United States
(12) Patent Application Publication
(10) Pub. No.: US 2019/0286272 A1
(43) Pub. Date: Sep. 19, 2019

(54) TOUCH CONTROL DISPLAY PANEL, TOUCH CONTROL METHOD AND TOUCH CONTROL DISPLAY DEVICE

(71) Applicant: Wuhan China Star Optoelectronics Semiconductor Display Technology Co., Ltd., Wuhan (CN)

(72) Inventor: Xiaoliang FENG, Shenzhen (CN)

(21) Appl. No.: 16/111,212

(22) Filed: Aug. 24, 2018

Related U.S. Application Data
(63) Continuation of application No. PCT/CN2018/087741, filed on May 22, 2018.

(30) Foreign Application Priority Data
Mar. 14, 2018 (CN) 201810211239.1

(51) Int. Cl. G06F 3/041

(52) U.S. Cl. CPC G06F 3/0416; G06F 3/044; G06F 3/0412

(57) ABSTRACT

A touch control display panel, a touch control method, and a touch control display device are disclosed. The touch control display panel includes a number of driving wires and a number of receiving wires, the driving wires and the receiving wires forming a coupling capacitor to convert a touch motion into a touch control signal. One side of the panel is provided with a notch, the notch dividing the panel into a number of independent circuit systems. The driving wires and the receiving wires in each circuit system may form an independent loop, and thus the touch control signal can be transmitted through the loop. Therefore, the screen occupation ratio can be increased, the calculation process of the position coordinates can be optimized, and the calculation accuracy can be improved.

### CROSS-REFERENCE TO RELATED APPLICATIONS

The present application is a continuation-application of International (PCT) Patent Application No. PCT/CN2018/087741 filed May 22, 2018, which claims foreign priority of Chinese Patent Application No. 201810211239.1, filed on Mar. 14, 2018 in the State Intellectual Property Office of China, the entire contents of which are hereby incorporated by reference.

### TECHNICAL FIELD

The present disclosure relates to a technical field of display technology, and particularly to a touch control display panel, a touch control method and a touch control display device.

### BACKGROUND

As an input medium, a touch screen is currently the simplest and most convenient human-computer interaction means. A touch control display panel is roughly divided into a resistive touch control display panel, a capacitive touch control display panel, an optical touch control display panel, an acoustic wave touch control display panel, and an electromagnetic touch control display panel, according to different sensing methods. Since the capacitive touch control display panel has merits of quick response, a high reliability, and a high durability, the capacitive touch control display panel has been widely used in electronic products.

As shown in FIG. 1, in a conventional capacitive touch control display panel in the display region A, a driving wire Tx and a receiving wire Rx respectively made of two layers of ITO (indium tin oxide) conductive material layers, are non-coplanarly and separately disposed on two parallel planes, and are electrically insulated from each other, in which a plurality of elongated driving wires Tx are disposed in the X direction, and a plurality of elongated receiving wires Rx are disposed in the Y direction (substantially perpendicular to the X direction). A touch control signal transmission line 3 of the receiving wire Rx may be connected to a processing chip 1 from a lower side of the display region; and the touch control signal transmission wire 4 of the driving wire Tx may need to be led out from both the left and right sides of the display region, extending along the Y direction and being connected to the processing chip 1, and therefore, a touch control signal transmission line area 2 exists on both the left and right sides of the display region. On the other hand, in order to avoid the disposing region of a camera and an earpiece on the display screen, the touch screen is provided with a notch, and the configuration of the notch cuts off the driving wire Tx and the receiving wire Rx in matrix distribution. In order to avoid circuit cutoff, the touch control signal transmission line is used to connect the driving wire Tx and the receiving wire Rx, on the lateral side of the notch, and the touch control signal transmission line is disposed below the notch. The inventor of the present disclosures find that the conventional distribution method for the touch control signal transmission lines not only occupies the area of the display region, reduces the screen occupation ratio of the display screen, and is against to the realization of fill screen, but also causes pixels missing at the edge of the notch, thus affecting the accuracy of calculation, further affecting the recognition effect.

### SUMMARY

The present disclosure provides a touch control display panel, a touch control design method thereof, and a touch control display device, aimed to solve the problems of the related art that, in order to avoid the setting region of the camera and the earpiece on the display screen, the screen occupation ration is reduced and the pixels are missing, and the touch control recognition is affected.

To solve the above technical problem, one of the technical solutions adopted in the present disclosure is to provide a touch control display panel. The touch control display panel includes: a plurality of driving wires disposed along a first direction and a plurality of receiving wires disposed along a second direction, with the first direction and the second direction substantially perpendicular to each other. The driving wires and the receiving wires form a coupling capacitor, the coupling capacitor configured to convert a touch motion into a touch control signal. A notch is formed on one side of the touch control display panel, the notch dividing the touch control display panel into several independent circuit systems, the driving wires and the receiving wires in each circuit system both forming an independent loop, to enable the touch control signal to be transmitted through the loop. The touch control display panel further includes a plurality of connection blocks. The connection blocks comprise a plurality of pairs of driving connection blocks and a plurality of pairs of receiving connection blocks. Each pair of driving connection blocks are electrically connected to both ends of two adjacent driving wires, to enable the adjacent driving wires to form a loop, while each pair of receiving connection blocks are electrically connected to both ends of two adjacent receiving wires, to enable the adjacent receiving wires to form a loop.

In order to solve the above technical problems, another technical solution adopted in the present disclosure is to provide a touch control method. The touch control method includes: providing a touch control display panel. The touch control display panel including: a plurality of driving wires disposed along a first direction and a plurality of receiving wires disposed along a second direction, with the first direction and the second direction substantially perpendicular to each other, the driving wires and the receiving wires forming a coupling capacitor, the coupling capacitor configured to convert a touch motion into a touch control signal; and a notch formed on one side of the touch control display panel, the notch dividing the touch control display panel into several independent circuit systems, the driving wires and the receiving wires in each circuit system both forming an independent loop, to enable the touch control signal to be transmitted through the loop. The method further includes determining the circuit system where the touch motion is located, performing signal processing according to the circuit system where the touch motion is located, and outputting the touch control effect of the display panel corresponding to the signal processing result.

In order to solve the above technical problems, a further technical solution adopted in the present disclosure is to provide a touch control display device. The touch control display device includes a touch control display panel, the touch control display panel including: a plurality of driving wires disposed along a first direction and a plurality of receiving wires disposed along a second direction, with the first direction and the second direction substantially perpendicular to each other, the driving wires and the receiving wires forming a coupling capacitor, the coupling capacitor configured to convert a touch motion into a touch control signal; and a notch formed on one side of the touch control display panel, the notch dividing the touch control display panel into several independent circuit systems, the driving wires and the receiving wires in each circuit system both forming an independent loop, to enable the touch control signal to be transmitted through the loop.

The beneficial effect of the above embodiments lies in that: by dividing the touch control display panel provided with at least one notch into several independent circuit systems, the driving wires and the receiving wires in each circuit system may form an independent loop, so each loop may only require one touch control signal transmission line for signal transmission, thereby reducing the area of the invalid region occupied by the touch control signal transmission lines and improving the screen occupation ratio. On the other hand, as the coordinates of the touch point in each region of the touch control display panel are calculated by each independent circuit system, the calculation accuracy is comparatively high and the recognition result is more accurate.

### BRIEF DESCRIPTION OF THE DRAWINGS

FIG. 1 is a schematic structural diagram of a conventional touch control display panel.

FIG. 2 is a schematic diagram of an overall structure of a touch control display panel of the present disclosure.

FIG. 3 is a partially enlarged schematic view of circle B in FIG. 2.

FIG. 4 is a schematic diagram of a circuit system division in another embodiment of the touch control display panel of the present disclosure.

FIG. 5 is a flowchart of an embodiment of a touch control method according to the present disclosure.

FIG. 6A to 6C are schematic structural diagrams of different touch control display panels in other embodiments of the present disclosure.

FIG. 7 is a flowchart of another embodiment of a touch control method according to the present disclosure.

FIG. 8 is a schematic structural diagram of a touch control display device according to an embodiment of the present disclosure.

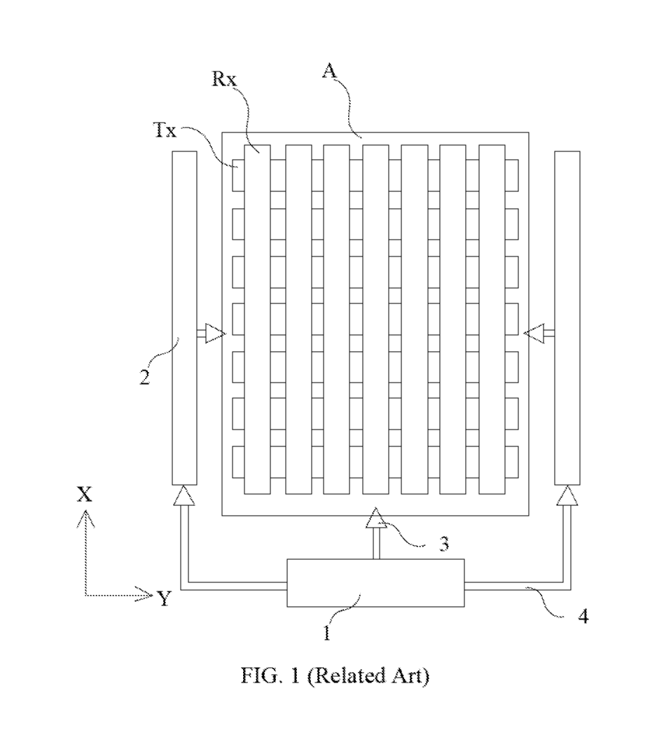

### DETAILED DESCRIPTION

The technical solutions in the embodiments of the present disclosure will be clearly and completely described as follows. Apparently, the described embodiments are merely a part but not all of the embodiments of the present disclosure. All other embodiments obtained by the ordinary skilled in the art according to the embodiments of the present disclosure without any creative efforts shall fall into the protection scope of the present disclosure.

The terms of “first” and “second” in this disclosure are merely used for descriptive purposes and are not to be construed as indicating or implying relative importance or implying the number of indicated technical features. Thus, features defined as “first”, “second” may explicitly or implicitly include at least one of such features. In the description of the present disclosure, the meaning of “a plurality of” means at least two, such as two, or three, etc., unless clearly and specifically defined otherwise. Directional terms (such as “top” and “down”, “left”, “right”, “front”, “rear” and so on) mentioned in the embodiments of the present disclosure, are only directions to explain relative position relationship and motions between components in a specific posture (as shown in the attached drawings). If the specific posture changes, the direction terms also changes accordingly. Further, the terms “include” and “have” and any variants thereof are intended to cover a non-exclusive inclusion. For example, a process, method, or system, product, or device that comprises a series of steps or components is not limited to the listed steps or components, but may optionally include unlisted steps or components, or optionally may also include other steps, or components, inherent to these processes, methods, products, or devices.

References herein to “an embodiment” means that a particular feature, structure, or characteristic described in connection with an embodiment can be included in at least one embodiment of the present disclosure. The appearances of such phrases in various places in the disclosure are not necessarily all referring to the same embodiment, nor are separate or alternative embodiments mutually exclusive with other embodiments. It will be understood by those skilled in the art, both explicitly and implicitly, that the embodiments described herein can be combined with other embodiments.

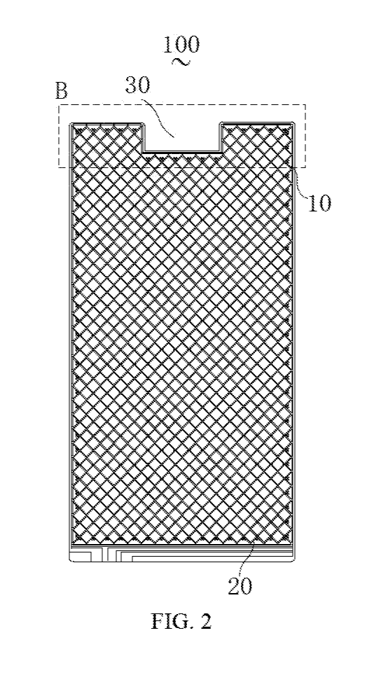

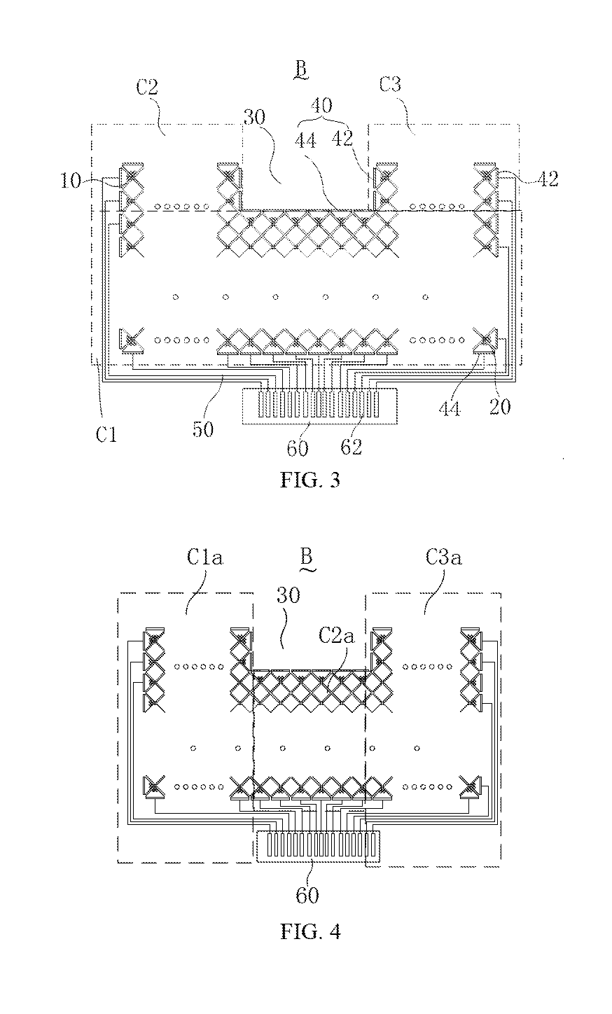

Please referring to FIG. 2 and FIG. 3, FIG. 2 is a schematic diagram of an overall structure of a touch control display panel of the present disclosure, and FIG. 3 is a partially enlarged schematic view of a circle B in FIG. 2. The touch control display panel 100 may include a plurality of driving wires 10 disposed along a first direction and a plurality of receiving wires 20 disposed along a second direction. The first direction and the second direction are substantially perpendicular to each other. The driving wires 10 and the receiving wires 20 form a coupling capacitor, and the coupling capacitor is configured to convert a touch motion into a touch control signal. One side of the touch control display panel 100 is provided with a notch 30. The notch 30 divides the touch control display panel 100 into several independent circuit systems. Both the driving wires 10 and the receiving wires 20 in each circuit system can form an independent loop, and thus touch control signals can be transmitted through the loop.

Specifically, the driving wires 10 and the receiving wires 20 may be located on different layers of the touch control display panel 100, with an insulating layer provided between the two layers to insulate them from each other. The mutually insulated driving wires 10 and receiving wires 20 are induced with each other, to form the coupling capacitor. When the touch control display panel 100 receives a touch motion, the touch motion changes the relative position of the coupling capacitor, causing an electric field change therebetween, thereby generating a touch control signal. The touch control signal can be transmitted by the independent circuit systems. In the present embodiment, the driving wires 10 are disposed in a substantially horizontal direction, and the receiving wires 20 are disposed in a substantially vertical direction.

A camera and an earpiece are provided on the display screen. To prevent affecting the function of the camera and the earpiece, the notch 30 is provided in the region of the touch control display panel 100 corresponding to the camera and the earpiece. Due to the different models of mobile phones, the positions of the camera and the earpiece on the display screen are not fixed, and the camera and the earpiece may also be separately disposed. Therefore, the position and the number of the notches 30 provided on the touch control display panel 100 are also variable. For example, the number of notch 30 may be one, and the notch 30 may be located above, below, on a left side or right side of the touch control display panel 100, and may also be located in region of the upper left corner or the upper right corner. The number of the notches 30 may also be two, whose positions may be the same side of the touch control display panel 100, or may be located on the opposite sides of the touch control display panel 100, and may also be located positions on two adjacent sides. In this embodiment, one notch 30 is provided. The notch 30 is located at a middle position on the touch control display panel 100, so that the numbers of pixel units on the left and right sides of the touch control display panel 100 are equal.

Further, the touch control display panel 100 may also include a plurality of connection blocks 40. The connection blocks 40 comprise a plurality of pairs of driving connection blocks 42 and a plurality of pairs of receiving connection blocks 44. Each pair of driving connection blocks 42 are disposed at both ends of two adjacent driving wires 10, and electrically connected to the adjacent driving wires 10, thus the driving wires 10 form a loop, while each pair of receiving connection blocks 44 are disposed at both ends of two adjacent receiving wires 20, and electrically connected to the adjacent receiving wires 20, thus the receiving wires 20 form a loop.

Specifically, in the present embodiment, since the driving wires 10 are substantially horizontally distributed, the driving connection blocks 42 are therefore distributed on both vertical sides of edges of the touch control display panel 100 in the vertical direction of the touch control display panel 100 as well as on both vertical sides of edges of the notch 30, and the two opposite ends of each driving connection block 42 which are substantially distributed vertically, respectively connect to two adjacent driving wires 10, so that the transmission loop of the driving wires 10 can be formed. Because the receiving wires 20 are substantially vertically distributed, the receiving connection blocks 44 are distributed along a horizontal direction of the touch control display panel 100 on both horizontal sides of edges of the touch control display panel 100 and on the horizontal bottom edge of the notch 30. Two opposite receiving ends of each receiving connection blocks 44 which are substantially horizontally distributed, respectively connect to two adjacent receiving wires 20 so that a transmission loop of the receiving wires 20 can be formed.

Further, the touch control display panel 100 may also include a plurality of touch control signal transmission lines 50 and a processing chip 60. The touch control signal transmission lines 50 transmit the touch control signal of each independent circuit system to the processing chip 60. Specifically, one end of each touch control signal transmission line 50 is connected to the connection block 40, and the other end is electrically connected to a bond pad 62. The bond pad 62 is further electrically connected to the processing chip 60, so that the touch control signal in each loop is transmitted to the processing chip 60. The processing chip 60 is configured to calculate a position of the touch point where the touch control signal is located according to the touch control signal transmitted by the touch control signal transmission line 50, further to form a corresponding touch control effect according to the position of the touch point.

Further, the touch control signal transmission line 50 is electrically connected with one of the connection blocks 40 in the same loop. Specifically, the same loop may be a driving loop formed by the driving wires 10 and two driving connection blocks 42. The touch control signal transmission line 50 is electrically connected to one of the driving connection blocks 42 so as to transmit the touch control signal in the driving loop to the processing chip 60. The same loop may also be a receiving loop formed by the receiving wires 20 and two receiving connection blocks 44. The touch control signal transmission line 50 is electrically connected to one of the receiving connection blocks 44, thereby transmitting the touch control signal in the receiving loop to the processing chip 60.

Further, the notch 30 is a U-shaped structure. The notch 30 divides the touch control display panel 100 into three independent circuit systems. Of course, in other embodiments, the shape of the notch 30 may also be other regular or irregular shapes, such as trapezoid and regular hexagon. The independent circuit systems are specifically divided according to the shape of the notch 30, and for example, the notch in regular hexagon shape may divide the touch control display panel 100 into five independent circuit systems.

Further, in the present embodiment, the circuit system may include a first circuit system C1, a second circuit system C2, and a third circuit system C3. The first circuit system C1 extends from a row where a bottom side of the notch 30 is located to an edge of the touch control display panel 100, in a direction away from the notch 30. The second circuit system C2 extends from a column where one lateral side of the notch 30 is located to an edge of the touch control display panel 100 in a direction away from the notch 30. The third circuit system C3 extends from a column where the other lateral side of the notch 30 is located to an edge of the touch control display panel 100, in a direction away from the notch 30.

In this embodiment, the electrical connection relationship between the touch control signal transmission lines 50 and the driving connection blocks 42 may be configured as follows. In the first circuit system C1, the touch control signal transmission lines 50 are continuously connected with the driving connection blocks 42 disposed on either side of two sides of the touch control display panel 100, or in cross connection with the drive connection blocks 42 on both sides. In the second circuit system C2, the touch control signal transmission lines 50 are continuously connected with the driving connection blocks 42 on the side away from the notch 30. In the third circuit system C3, the touch control signal transmission lines 50 are continuously connected with the driving connection blocks 42 on the side away from the notch 30.

The electrical connection relationship between the touch control signal transmission line 50 and the receiving connection blocks 44 may be configured as follows. The touch control signal transmission line 50 is only continuously connected with the receiving connection blocks 44 on the side of the first circuit system C1 of the touch control display panel 100, away from the notch 30.

Further, the touch points in the circuit system are in one-to-one correspondence with a pixel unit in the touch control display panel 100. The first circuit system C1 includes (m−w) rows and n columns of pixel units, the second circuit system C2 includes w rows of pixel units and x₁ columns of pixel units, and the third circuit system C3 includes w rows of pixel units and x₂ columns of pixel units, where m represents the total number of rows of the pixel units included in the touch control display panel 100, n represents the total number of columns of pixel units included in the touch control display panel 100, w represents the number of rows of pixel units occupied by the notch 30, and x₁ and x₂ represent numbers of columns of the pixel units included in the touch control display panel 100 on two sides of the notch 30, m, n, w, x₁, x₂ are natural numbers, with w<m, x1+x2<n. Specifically, the principle that the touch control display panel 100 recognizes the touch motion is to recognize the position coordinates of the pixel unit in the touch control display panel 100, and the position coordinates of the pixel unit constitute the position coordinates of the touch point, and thus the touch point in the circuit system is in one-to-one correspondence with the pixel unit in the touch control display panel 100. According to the number of rows and the number of columns of the pixel unit included in the three circuit systems, the number of pixel units included in the first circuit system C1 can be calculated as follows.

P1=(m−w)×n.

The number of pixel units included in the second circuit system C2 is as follows.

P2=x₁×w.

The number of pixel units included in the third circuit system C3 is as follows.

P3=x₂×w.

For the convenience of calculation, in the present embodiment, the U-shaped notch 30 is disposed at a middle position of the touch control display panel 100, thus the notch 30 exactly dividing the loop of the driving wire 10 averagely, i.e., x₁=x₂, and thus the number of pixels of the second circuit system C2 and the number of pixels of the third circuit system C3 on the left and right sides of the notch 30 are equal, that is, P2=P3=x₁×w.

Alternatively, please referring to FIG. 4 and continuing to refer to FIG. 3, FIG. 4 is a schematic diagram of a circuit system division in another embodiment of the touch control display panel of the present disclosure. In other embodiments, the circuit systems may also be divided into: a first circuit system Cla extending from the column where one side of the U-shapes of the notch 30 is located to the edge of the touch control display panel 100 in a direction away from the notch 30, a second circuit system C2a extending from the bottom edge of the notch 30 to the edge of the touch control display panel 100 in a direction away from the notch 30, and a third wiring system C3a extending from the column where the other side of the notch 30 is located to the edge of the touch control display panel 100 in a direction away from the notch 30.

In this case, the first circuit system Cla includes m rows of pixel units and x₁ columns of pixel units, the second circuit system C2a includes (m−w) rows and (n−x₁−x₂) columns of pixel units, and the third circuit system C3a includes m rows of pixel units and x₂ columns of pixel units. The number of pixel units included in the first circuit system C1a is as follows.

P1a=m×x₁.

The number of pixel units included in the second circuit system C2a is as follows.

P2a=(m−w)×(n−x₁−x₂).

The number of pixel units included in the third circuit system C3a is:

P3a=m×x₂.

Compared with the circuit system division method of other embodiments, the advantage of this embodiment of the present disclosure lies in that the embodiment of the present disclosure configures the region that is not affected by the notch 30 as a circuit system with a relatively larger area, and the region affected by the notch 30 as the other circuit system with a smaller area. When the processing chip 60 calculates the ordinates of the touch control point, the calculation amount may be smaller than that of other division methods. Therefore, when dividing the circuit systems of the touch control display panel 100, it is typical to divide the touch control display panel 100 into a large circuit system and several small circuit systems, thereby reducing the computational complexity of the processing chip 60.

The beneficial effect of the above embodiment is that the touch control display panel 100 provided with the U-shaped notch 30 is divided into a plurality of independent circuit systems, with a pair of connection blocks 40 provided in each loop, and one of the connection blocks 40 is connected to the processing chip 60 through the touch control signal transmission line 50, so as to convert the touch motion received by the touch control display panel 100 into a touch control signal through each independent circuit system and transmit to the processing chip 60 through the connection block 40 and the touch control signal transmission line 50. The processing chip 60 thus further calculates the pixel unit where the touch point is located and outputs the touch control display effect of the corresponding pixel unit. Since each loop requires only one touch control signal transmission line 50 for signal transmission, the touch control signal transmission line is not provided on the side where the notch 30 is provided, and the number of touch control signal transmission lines is halved on the side without the notch 30, thus reducing the area of the invalid region, and increasing the screen occupation ratio. On the other hand, since the touch point coordinates of each region of the touch control display panel 100 are calculated by each independent circuit system, the calculation accuracy is comparatively high, and the recognition results are more accurate.

Referring to FIG. 5, as well as FIG. 3. FIG. 5 is a schematic flowchart of an embodiment of a touch control method according to the present disclosure. The touch control method may include following blocks.

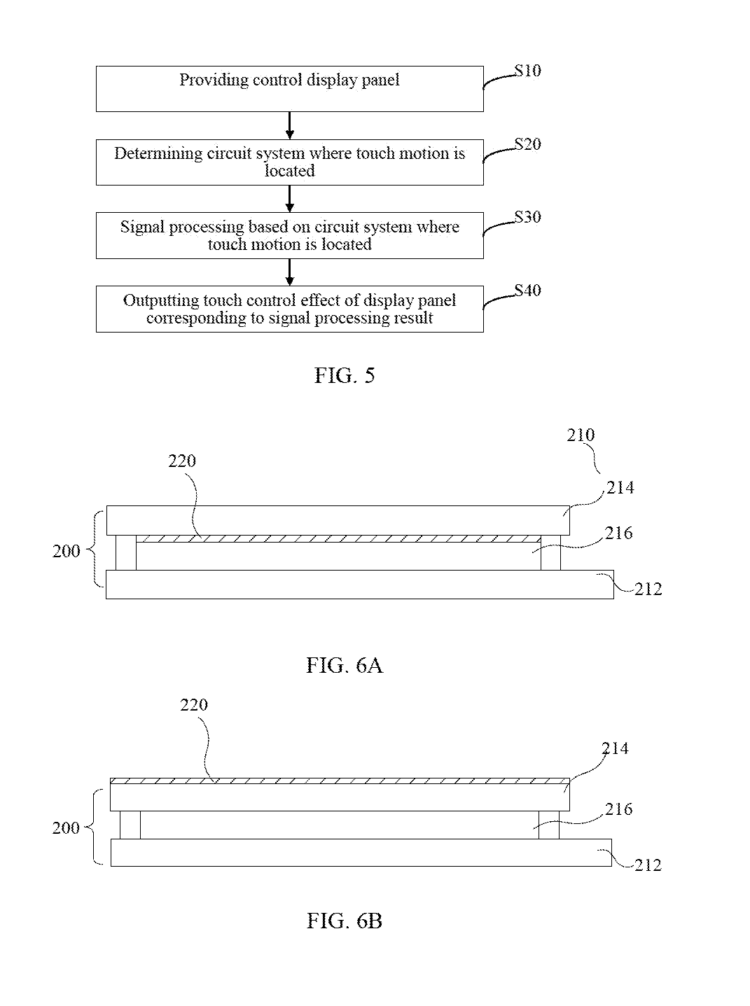

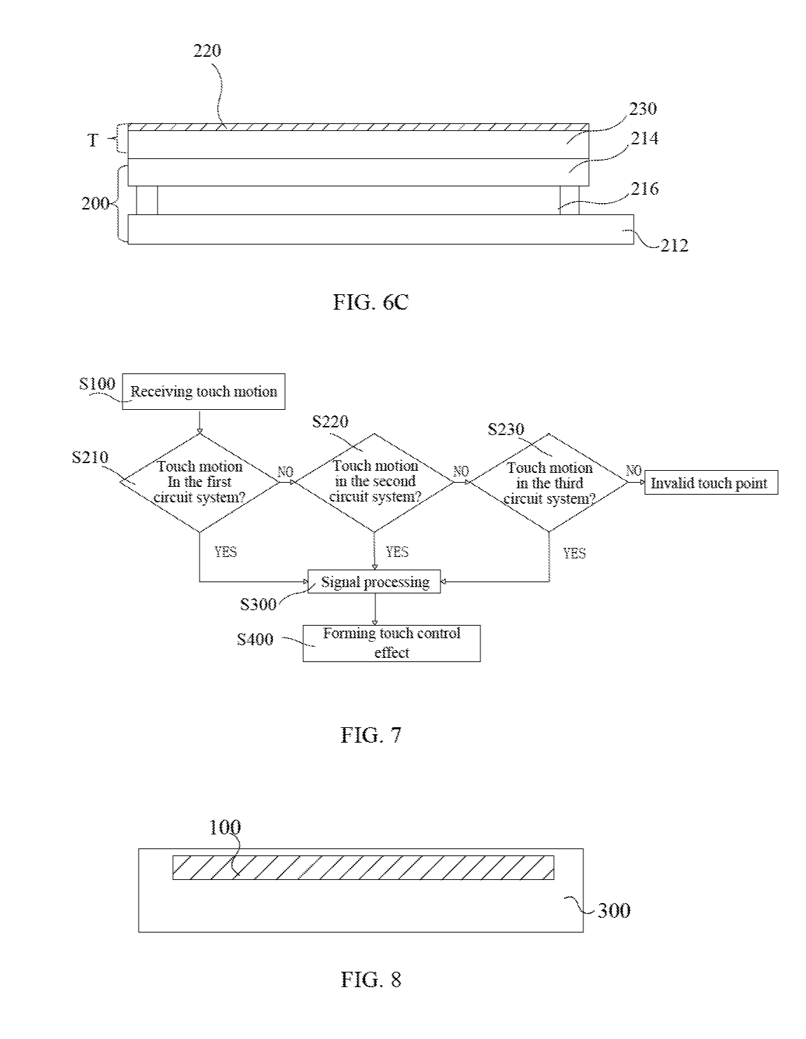

In S10, a touch control display panel 100 is provided. The touch control display panel 100 is the touch control display panel 100 described above. The touch control display panel 100 may have a variety of structures. Referring to FIGS. 6A-6C, FIGS. 6A to 6C are structural schematic diagrams of different touch control display panels in embodiments of the present disclosure. The touch control display panel 200 in FIG. 6A includes a display panel 210 and a touch control unit 220 disposed on the display panel. The touch control unit 220 may be formed inside the display panel 210. For example, the display panel 210 may be a liquid crystal display panel, which includes a thin film transistor array substrate 212, a color filter substrate 214, and a liquid crystal layer 216. The liquid crystal layer 216 is located between the thin film transistor array substrate 212 and the color filter substrate 214. The touch control unit 220 is disposed on an inner surface of the color filter substrate 214. In other words, the touch control unit 220 is located between the color filter substrate 214 and the liquid crystal layer 216, i.e., in the so-called in-cell design. The display panel 210 may also be an organic light emitting display panel, an electrophoretic display panel, or a plasma display panel. In addition to being formed inside the display panel 210, the touch control unit 220 may also be combined with the display panel 210 in other ways, as shown in FIG. 6B and FIG. 6C. Firstly, as shown in FIG. 6B, the touch control unit 220 may be formed on an outer surface of the color filter substrate 214, i.e., in the so-called On-cell design. Of course, the touch control unit 220 can also be fabricated on a substrate (for example, an auxiliary substrate 230), and then the substrate 230 on which the touch control unit 220 is formed is attached on the outer surface of the color filter substrate 214, as shown in FIG. 6C, i.e., in the so-called added-on design. It should be noted that, the in FIG. 6C, substrate 230 (i.e., the auxiliary substrate 230) and the touch control unit 220 constitute the touch control substrate T. It can be known from the above that the touch control unit 220 of the present disclosure can be fabricated on a color filter substrate 214, a thin film transistor array substrate 212, or an auxiliary substrate 230, but not limited thereto.

Block S20 is further performed to determine the circuit system where the touch motion is located.

The determining the circuit system where the touch motion is located further includes the following sub-blocks.

The method further includes determining whether the touch motion is in the first circuit system C1. The coordinate of the touch point where the touch motion is located is assumed to be (Rᵢ, Tⱼ), i fefers to the column of the pixel unit where the touch point is located, and j refers to the row of the pixel unit where the touch point is located. Because the first circuit system C1 includes (m−w) rows and n columns of pixel units, when 0≤i≤n and 0≤j≤(m−w), it would be determined that the touch point is located in the first circuit system C1.

When it is determined that the touch motion is not in the first circuit system C1, the method would then include determining whether the touch motion is in the second circuit system C2. Specifically, when the touch point does not meet the coordinate range of the midpoint of the first circuit system C1, it would be further determined whether the touch point is located in the second circuit system C2. When 0≤i≤x₁ and (m−w)≤j≤m, it would be determined that the touch point is located in the second circuit system C2.

When it is determined that the touch motion is not in the second circuit system C2, the method would then include determining whether the touch motion is in the third circuit system C3. When the touch point does not meet the coordinate range of the midpoint of the second circuit system C2, it would be further determined whether the touch point is located in the third circuit system C3. Specifically, when n−x₂≤i≤n and (m−w)≤j≤m, it would be determined that the touch point is located in the third circuit system C3.

When it is determined that the touch motion is not in the third circuit system C3, the touch motion is invalid. Specifically, if the coordinates of the touch point do not conform to the first circuit system C1, as well as the second circuit system C2 and the third circuit system C3, it would be determined that the touch point is invalid, that is, the touch motion is invalid.

After obtaining a determining result of the touch motion, the following blocks are further performed.

In S30, the method includes performing signal processing according to the circuit system where the touch motion is located. For example, the first circuit system C1 generates a touch control signal according to the touch motion, and further transmits the touch control signal to the processing chip 60 through connecting to the touch control signal transmission line 50 of the first circuit system C1.

In S40, the method may include outputting the touch control effect of the display panel corresponding to the signal processing result. Specifically, the processing chip 60 receives the touch control signal transmitted through the touch control signal transmission line 50 in any of the above circuit systems, and performs signal processing so as to form a corresponding touch control effect, and displays through the touch control display panel 100.

Please referring to FIG. 7, and continuing to refer to FIG. 3, FIG. 7 is a schematic flowchart of another embodiment of a touch control method according to the present disclosure. The touch method includes the following blocks.

In S100, the method may include receiving a touch motion. The touch control display panel 100 described above receives the touch motion.

In S210, the method may include determining whether the touch motion is in the first circuit system C1. The coordinate of the touch point where the touch motion is located is assumed to be (Rᵢ, Tⱼ), i refers to the column of the pixel unit where the touch point is located, and j refers to the row of the pixel unit where the touch point is located. Because the first circuit system C1 includes (m−w) rows and n columns of pixel units, when 0≤i≤n and 0≤j<(m−w), it would be determined that the touch point is located in the first circuit system C1.

When it is determined that the touch point is located in the first circuit system C1, block S300 of signal processing is further performed. Specifically, the first circuit system C1 transmits the touch control signal generated by the touch motion to the processing chip 60 via the touch control signal transmission line 50, and the processing chip 60 determines the coordinates of the touch point according to the touch control signal, thereby obtaining the corresponding pixel unit of the touch point.

When it is determined that the touch point is not located in the first circuit system C1, block S220 is further performed to determine whether the touch motion is located in the second circuit system C2. Specifically, when 0≤i≤xⱼ and (m−w)≤j≤m, it is determined that the touch point is located in the second circuit system C2. If it is determined that the touch point is located in the second circuit system C2, block S300 of signal processing is further performed. Specifically, the second circuit system C2 transmits the touch control signal generated by the touch motion to the processing chip 60 through the touch control signal transmission line 50, and the processing chip 60 determines the coordinates of the touch point according to the touch control signal, thereby obtaining corresponding pixel unit of the touch point.

When it is determined that the touch point is not located in the second circuit system C2, block S230 is further performed to determine whether the touch motion is located in the third circuit system C3. Specifically, when n−x₂≤i≤n and (m−w)≤j≤m, it is determined that the touch point is located in the third circuit system C3. If it is determined that the touch point is located in the third circuit system C3, block S300 of signal processing is further performed. Specifically, the third circuit system C3 transmits the touch control signal generated by the touch motion to the processing chip 60 through the touch control signal transmission line 50. The processing chip 60 determines the coordinates of the touch point according to the touch control signal, thereby obtaining the corresponding pixel unit of touch point.

When it is determined that the touch point is not located in the third circuit system C3, the touch point is invalid, and the touch control display panel 100 does not perform corresponding operations.

After performing signal processing on the touch motion, block S400 is further performed to form a touch control effect. Specifically, the processing chip 60 forms the touch control effect corresponding to the corresponding pixel unit according to the pixel unit corresponding to the touch point, and displays the touch control effect through the touch control display panel 100.

The beneficial effect of the above embodiments lies in that, by dividing the touch region of the touch control display panel into a plurality of mutually independent circuit systems, each time only the circuit system where the touch motions happen works, and the other circuit systems do not work, thereby reducing the computational complexity of the processing chip. Moreover, the coordinate points of the region where the notch is located are removed from the overall circuit system, which contributes to a more accurate processing result of the processing chip.

The present disclosure further provides a touch control display device 300. Referring to FIG. 8, FIG. 8 is a schematic structural diagram of a touch control display device according to an embodiment of the present disclosure. The touch control display device 300 includes the touch control display panel 100 in the above embodiments, and the touch design method of the touch control display device 300 is the touch design method in the above embodiments. The structure and a touch control design method of the touch control display panel 100 should be referred to the above description and no further explanation is given here.

The above description depicts merely some exemplary embodiments of the disclosure, but is not meant to limit the scope of the disclosure. Any equivalent structure or flow transformations made to the disclosure, or any direct or indirect applications of the disclosure on other related fields, shall all be covered within the protection of the disclosure.

What is claimed is:

1. A touch control display panel, comprising:
a plurality of driving wires disposed along a first direction and a plurality of receiving wires disposed along a second direction, with the first direction and the second direction substantially perpendicular to each other, the driving wires and the receiving wires forming a coupling capacitor, the coupling capacitor configured to convert a touch motion into a touch control signal;
a notch defined in one side of the touch control display panel, the notch dividing the touch control display panel into several independent circuit systems, the driving wires and the receiving wires in each circuit system both forming an independent loop, to enable the touch control signal to be transmitted through the loop; and
a plurality of connection blocks, the connection blocks comprising a plurality of pairs of driving connection blocks and a plurality of pairs of receiving connection blocks;
wherein each pair of the driving connection blocks are disposed at both ends of two adjacent driving wires, and electrically connected to the adjacent driving wires, to enable the adjacent driving wires to form a loop; and
each pair of the receiving connection blocks are provided at both ends of two adjacent receiving wires, and electrically connected to the adjacent receiving wires, to enable the adjacent receiving wires to form a loop.

2. The touch control display panel of claim 1, wherein, the notch of the touch control display panel is U-shaped, the U-shaped notch dividing the touch control display panel into three independent circuit systems, the driving wires and the receiving wires in each circuit system both forming an independent loop, to enable the touch control signal to be transmitted through the loop.

3. The touch control display panel of claim 1, further comprising a plurality of touch control signal transmission lines and a processing chip, and
the touch control signal transmission lines transmit the touch control signal of each independent circuit system to the processing chip.

4. The touch control display panel of claim 3, wherein, each of the touch control signal transmission lines is electrically connected with one of the connection blocks in the loop the same with the touch control signal transmission line.

5. The touch control display panel of claim 2, wherein,
the circuit systems comprise a first circuit system, a second circuit system, and a third circuit system;
the first circuit system extends from a row where a bottom side of the U-shaped notch is located to an edge of the touch control display panel, in a direction away from the notch;
the second circuit system extends from a column where one lateral side of the notch is located to an edge of the touch control display panel, in a direction away from the notch; and
the third circuit system extends from a column where another lateral side of the notch is located to an edge of the touch control display panel, in a direction away from the notch.

6. The touch control display panel of claim 5, wherein, a touch point in the circuit system is in a one-to-one correspondence with a pixel unit in the touch control display panel,
the first circuit system comprising m-w rows of pixel units and n columns of pixel units, the second circuit system comprising w rows of pixel units and x₁ columns of pixel units, and the third circuit system comprising w rows of pixel units and x₂ columns of pixel units, where m represents a total number of rows of the pixel units included in the touch control display panel, n represents a total number of columns of pixel units included in the touch control display panel, w represents the number of rows of pixel units occupied by the notch, x₁ and x₂ represent the numbers of columns of the pixel units included in the touch control display panel on two sides of the notch, and m, n, w, x₁, x₂ are natural numbers, with w<m, x₁+x₂<n.

7. The touch control display panel of claim 1, wherein, the number of the notch is one, one notch is located at one lateral side of the touch control display panel, and the numbers of pixel units on the left side and right side of the touch control display panel are equal.

8. The touch control display panel of claim 3, further comprising a bond pad, with one end of the bond pad electrically connected to the touch control signal transmission line, and an opposite end of the bond pad electrically connected to the processing chip.

9. The touch control display panel of claim 4, wherein, each of the touch control signal transmission lines is only connected to the receiving connection block away from one lateral side of the notch.

10. A touch control method, comprising:
providing a touch control display panel, the touch control display panel comprising:
a plurality of driving wires disposed along a first direction and a plurality of receiving wires disposed along a second direction, the first direction and the second direction substantially perpendicular to each other, the driving wires and the receiving wires forming a coupling capacitor, the coupling capacitor configured to convert a touch motion into a touch control signal, and
a notch formed on one side of the touch control display panel, the notch dividing the touch control display panel into several independent circuit systems, the driving wires and the receiving wires in each of the circuit systems both forming an independent loop at the notch, to enable the touch control signal to be transmitted through the loop;
determining the circuit system where the touch motion is located;
performing signal processing according to the circuit system where the touch motion is located; and
outputting the touch control effect of the display panel corresponding to the signal processing result.

11. The touch control method of claim 10, wherein, the notch of the touch control display panel is U-shaped, the notch dividing the touch control display panel into three independent circuit systems;
the first circuit system extending from a row where a bottom side of the U-shaped notch is located to an edge of the touch control display panel, in a direction away from the notch;
the second circuit system extending from a column where one lateral side of the notch is located to an edge of the touch control display panel, in a direction away from the notch; and
the third circuit system extending from a column where another lateral side of the notch is located to an edge of the touch control display panel, in a direction away from the notch;
and the determining the circuit system where the touch motion is located is in a sequence of:
determining whether the touch motion is in the first circuit system;
when it is determined that the touch motion is not in the first circuit system, determining whether the touch motion is in the second circuit system;
when it is determined that the touch motion is not in the second circuit system, determining whether the touch motion is in the third circuit system; and
when it is determined that the touch motion is not in the third circuit system, confirming that the touch motion is invalid.

12. A touch control display device comprising a touch control display panel, the touch control display panel comprising:
a plurality of driving wires disposed along a first direction and a plurality of receiving wires disposed along a second direction, the first direction and the second direction substantially perpendicular to each other, the driving wires and the receiving wires forming a coupling capacitor, the coupling capacitor configured to convert a touch motion into a touch control signal; and
a notch defined in one side of the touch control display panel, the notch dividing the touch control display panel into several independent circuit systems, the driving wires and the receiving wires in each circuit system both forming an independent loop, to enable the touch control signal to be transmitted through the loop.

13. The touch control display device of claim 12, the touch control display panel further comprising a plurality of connection blocks, the connection blocks comprising a plurality of pairs of driving connection blocks and a plurality of pairs of receiving connection blocks, wherein:
each pair of the driving connection blocks are disposed at both ends of two adjacent driving wires, and electrically connected to the adjacent driving wires, to enable the adjacent driving wires to form a loop; and
each pair of the receiving connection blocks are provided at both ends of two adjacent receiving wires, and electrically connected to the adjacent receiving wires, to enable the adjacent receiving wires to form a loop.

14. The touch control display device of claim 13, wherein, the touch control display panel further comprises a plurality of touch control signal transmission lines and a processing chip, and
the touch control signal transmission lines transmit the touch control signal of each independent circuit system to the processing chip.

15. The touch control display device of claim 14, wherein, each of the touch control signal transmission lines is electrically connected with one of the connection blocks in the loop the same with the touch control signal transmission line, and the touch control signal transmission line is only connected to the receiving connection block away from a lateral side of the notch.

16. The touch control display device of claim 12, wherein, the notch is U-shaped, and the notch divides the touch control display panel into three independent circuit systems.

17. The touch control display device of claim 16, wherein, the circuit systems comprise a first circuit system, a second circuit system, and a third circuit system;
the first circuit system extends from a row where a bottom side of the U-shaped notch is located to an edge of the touch control display panel, in a direction away from the notch;
the second circuit system extends from a column where one lateral side of the notch is located to an edge of the touch control display panel, in a direction away from the notch; and
the third circuit system extends from a column where another lateral side of the notch is located to an edge of the touch control display panel, in a direction away from the notch.

18. The touch control display device of claim 17, wherein, a touch point in the circuit system is in a one-to-one correspondence with a pixel unit in the touch control display panel,
the first circuit system comprising m-w rows of pixel units and n columns of pixel units, the second circuit system comprising w rows of pixel units and x₁ columns of pixel units, and the third circuit system comprising w rows of pixel units and x₂ columns of pixel units, where m represents a total number of rows of the pixel units included in the touch control display panel, n represents a total number of columns of pixel units included in the touch control display panel, w represents the number of rows of pixel units occupied by the notch, x₁ and x₂ represent the number of columns of the pixel units included in the touch control display panel on two sides of the notch, and m, n, w, x₁, x₂ are natural numbers, with w<m, x₁+x₂<n.

19. The touch control display device of claim 12, wherein, the notch is located at a lateral side of the touch control display panel, and the numbers of pixel units on the left side and right side of the touch control display panel are equal.

20. The touch control display device of claim 14, wherein, the touch control display device further comprises a bond pad, with one end of the bond pad electrically connected to the touch control signal transmission line, and an opposite end of the bond pad electrically connected to the processing chip.
